(19) United States
(12) Patent Application Publication
(10) Pub. No.: US 2024/0168561 A1
(43) Pub. Date: May 23, 2024

(54) APPARATUS AND METHOD FOR INTERACTION BETWEEN WORKER AND AUTONOMOUS VEHICLE

(71) Applicant: ELECTRONICS AND TELECOMMUNICATIONS RESEARCH INSTITUTE, Daejeon (KR)

(72) Inventors: Seung-Jun LEE, Daejeon (KR); Do Wook KANG, Daejeon (KR); Woojin KIM, Daejeon (KR); Daesub YOON, Daejeon (KR)

(21) Appl. No.: 18/378,272

(22) Filed: Oct. 10, 2023

(30) Foreign Application Priority Data
Nov. 23, 2022 (KR) 10-2022-0158683
Apr. 5, 2023 (KR) 10-2023-0044715

(51) Int. Cl. G06F 3/01; B60Q 1/50; G05D 1/00; G06V 20/40; G06V 20/56; G06V 40/20

(52) U.S. Cl. CPC G06F 3/017; B60Q 1/507; G05D 1/0016; G06V 20/41; G06V 20/56; G06V 40/28

(57) ABSTRACT

A method performed in an autonomous vehicle for an interaction with a worker is provided. The method includes storing video frames output by capturing an outside of the autonomous vehicle, identifying a command of the worker based on the video frames, controlling a message indicating the command of the worker to be displayed on a display, performing at least one control operation for performing the command of the worker, and controlling a message indicating the at least one control operation to be displayed on the display.

### CROSS-REFERENCE TO RELATED APPLICATIONS

This application claims the benefit of Korean Patent Application No. 10-2022-0158683, filed on Nov. 23, 2022, and Korean Patent Application No. 10-2023-0044715, filed on Apr. 5, 2023, in the Korean Intellectual Property Office, the entire disclosures of which are incorporated herein by reference for all purposes.

### BACKGROUND

### 1. Field of the Invention

One or more embodiments relate to technology of controlling an autonomous vehicle.

### 2. Description of Related Art

In port logistics, a yard truck is utilized to move cargo such as containers to the front of a ship for loading the cargo onto the ship. A lot of research is being conducted on a method of optimizing container transportation scheduling, because the shorter the time a ship is parked in a port, the lower the transportation cost can be.

In addition, since an accident of a worker within a yard also causes a great loss in transportation business, unmanned technology within a yard is in progress. In this case, collaboration with a yard truck driver is carried out through remote monitoring through a control center. However, a yard truck is gradually being changed to an unmanned truck with introduction of autonomous driving technology, and accordingly, an existing method of collaborating with a yard truck driver through remote monitoring cannot be utilized. When an entire port is operated automatically, if an issue occurs in one place, the possibility of the entire port being shut down increases, and thus, a worker who controls autonomous vehicles on site will be necessary to solve the issue. Since an autonomous vehicle does not have a driver, a remote instruction or remote control is not a realistic solution from a technical or security aspect.

### SUMMARY

One or more embodiments are to provide technology for controlling an autonomous vehicle according to a hand signal of a worker.

The technical goal obtainable from the present disclosure is not limited to the above-mentioned technical goal, and other unmentioned technical goals may be clearly understood from the following description by those having ordinary skill in the technical field to which the present disclosure pertains.

According to an aspect, there is provided an apparatus for an interaction between a worker and an autonomous vehicle, the apparatus including a sensor unit including an infrared (IR) camera module and a light sensing module, a controller communicatively connected to the sensor unit and including a gesture analyzer, a command processor, and a display controller, a display communicatively connected to the display controller, and a storage connected to the sensor unit and the controller. The IR camera module may be configured to output video frames by capturing IR light incident on the IR camera module, wherein the video frames are stored in the storage, and further configured to output a first signal indicating a point in time at which sensing of IR light emitted from a light rod outside the autonomous vehicle starts and a second signal indicating a point in time at which the sensing of the IR light emitted from the light rod ends, the light sensing module may be configured to output a third signal in response to sensing a laser emitted from the light rod, the gesture analyzer may be configured to search for first video frames stored in the storage from the point in time indicated by the first signal to the point in time indicated by the second signal, in response to receiving the first signal and the second signal, configured to identify a command of the worker by analyzing the found first video frames, and configured to output a fourth signal indicating the command of the worker, the command processor may be configured to perform at least one control operation for performing the command of the worker in response to receiving the fourth signal, and further configured to output a fifth signal indicating the at least one control operation, and the display controller may be configured to control a message indicating the at least one control operation to be displayed on the display in response to receiving the fifth signal and further configured to control a message indicating that the autonomous vehicle is pointed out to be displayed on the display in response to receiving the third signal.

The sensor unit may further include a camera module, wherein the camera module may be configured to capture an outside of the autonomous vehicle and output second video frames, and the second video frames are stored in the storage.

The gesture analyzer may be configured to further search for the second video frames stored in the storage from the point in time indicated by the first signal to the point in time indicated by the second signal, in response to receiving the first signal and the second signal, and further configured to output the fourth signal based on an analysis of the found first video frames and the found second video frames.

The IR camera module, the light sensing module, and the camera module may be installed on a front side of the autonomous vehicle.

The display may be a light-emitting diode (LED) display.

The at least one control operation may include at least one of stopping, driving, or generating a new movement path.

The display controller may be further configured to control a message indicating the command of the worker to be displayed on the display in response to receiving the fourth signal.

According to another aspect, there is provided a method performed in an autonomous vehicle for an interaction with a worker, the method including storing video frames output by capturing an outside of the autonomous vehicle, identifying a command of the worker based on the video frames, controlling a message indicating the command of the worker to be displayed on a display, performing at least one control operation for performing the command of the worker, and controlling a message indicating the at least one control operation to be displayed on the display.

The identifying of the command of the worker based on the video frames may include, in response to generating a first signal indicating a point in time at which sensing of IR light emitted from a light rod outside the autonomous vehicle starts and a second signal indicating a point in time at which the sensing of the IR light emitted from the light rod ends, searching for the stored video frames from the point in time indicated by the first signal to the point in time indicated by the second signal, and identifying the command of the worker by analyzing the found video frames.

The performing of the at least one control operation for performing the command of the worker may include executing a process of generating a local path, and the controlling of the message indicating the at least one control operation to be displayed on the display may include controlling a message indicating that a local path is being generated to be displayed on the display.

According to another aspect, there is provided a method performed in an autonomous vehicle for an interaction with a worker, the method including storing video frames output by capturing an outside of the autonomous vehicle, in response to sensing a laser emitted from a light rod outside the autonomous vehicle, controlling a message indicating that the autonomous vehicle is pointed out to be displayed on a display, in response to generating a first signal indicating a point in time at which sensing of IR light emitted from the light rod outside the autonomous vehicle starts and a second signal indicating a point in time at which the sensing of the IR light emitted from the light rod ends within a predetermined time after the laser is sensed, identifying the command of the worker based on the video frames, controlling a message indicating the command of the worker to be displayed on the display, performing at least one control operation for performing the command of the worker, and controlling a message indicating the at least one control operation to be displayed on the display.

The identifying of the command of the worker based on the video frames may include searching for video frames stored from a point in time indicated by the first signal to a point in time indicated by the second signal, and identifying the command of the worker by analyzing the found video frames.

The controlling of the message indicating the command of the worker to be displayed on the display may include controlling a message indicating a command to start driving to be displayed on the display.

The performing of the at least one control operation for performing the command of the worker may include controlling the autonomous vehicle to start driving.

Additional aspects of embodiments will be set forth in part in the description which follows and, in part, will be apparent from the description, or may be learned by practice of the disclosure.

According to embodiments, there is provided a technical effect of controlling an autonomous vehicle according to a hand signal of a worker.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a concept of interaction between an autonomous vehicle and a hand signal worker;

FIG. 2 is a diagram illustrating a structure of a light rod of FIG. 1 according to an embodiment;

FIG. 3 is a block diagram illustrating an apparatus for interaction between a worker and an autonomous vehicle according to an embodiment;

FIG. 4A is a flowchart illustrating an example of a method performed in an autonomous vehicle for interaction with a worker according to an embodiment;

FIG. 4B is a diagram illustrating a scenario in which an obstacle occurs while an autonomous vehicle is driving on a global path and a worker guides to an avoidance path with a gesture;

FIG. 5A is a flowchart illustrating another example of a method performed in an autonomous vehicle for interaction with a worker according to an embodiment; and

FIG. 5B is a diagram illustrating a scenario in which a worker points out a stopped autonomous vehicle using a light rod and performs a gesture to operate the autonomous vehicle.

### DETAILED DESCRIPTION

The following detailed structural or functional description is provided as an embodiment only and various alterations and modifications may be made to embodiments. Here, the embodiments are not construed as limited to the disclosure and should be understood to include all changes, equivalents, and replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a “first” component may be referred to as a “second” component, or similarly, and the “second” component may be referred to as the “first” component within the scope of the right according to the concept of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical or scientific terms have the same meaning as commonly understood by one of ordinary skill in the art to which embodiments belong. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the embodiments with reference to the accompanying drawings, regardless of drawing numerals, like reference numerals refer to like elements and a repeated description related thereto will be omitted.

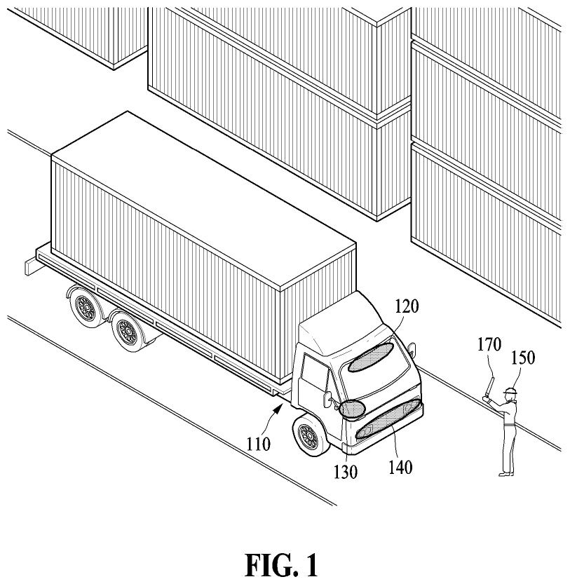

FIG. 1 is a diagram illustrating a concept of interaction between an autonomous vehicle and a hand signal worker.

An autonomous vehicle 110 shown in FIG. 1 may be, for example, a vehicle such as a yard truck that loads multiple cargos such as containers at a port logistics center and moves to the front of a ship. The autonomous vehicle 110 may be programmed to drive along a global path for performing a predetermined work schedule, for example, a path from a specific location in a port to the front of a ship. A hand signal worker 150 (hereinafter, simply referred to as a “worker”) may transmit, using a light rod 170, a signal to autonomous vehicles 110 that are stopped or may perform a gesture so that the autonomous vehicles 110 may be pointed out one by one and may be operated sequentially. In addition, when an obstacle occurs while the autonomous vehicle 110 moves along the global path, the worker 150 may transmit a signal to the autonomous vehicle 110 using the light rod 170 or may perform a gesture so that a command for solving the obstacle may be transmitted to the autonomous vehicle 110. An obstacle that may occur while the autonomous vehicle 110 is moving may include path interference between vehicles that occurs while multiple autonomous vehicles are operating, a simulation delay occurred by rescheduling, and the like. A command for solving an obstacle may include go left, go right, stop, and the like. In order to transmit a command to the autonomous vehicle 110, the light rod 170 may be mounted with an infrared (IR) emitter for emitting IR light and a laser emitter for emitting a laser, and the autonomous vehicle 110 may be mounted with an IR camera module for detecting the IR light emitted from the light rod 170 or capturing a gesture of the worker 150 through IR light emitted from the worker 150 and with a light sensor to detect the laser emitted from the light rod 170. The autonomous vehicle 110 may further include a camera module for capturing movement of the light rod 170 and/or a gesture of the worker 150 and a display for displaying a state of the autonomous vehicle 110. In an embodiment, the camera module, as shown in FIG. 1, may be installed on the front side (a portion indicated by reference number 120 in FIG. 1) of the autonomous vehicle 110. In an embodiment, the IR camera module, as shown in FIG. 1, may be installed next to the camera module on the front side (the portion indicated by the reference number 120 in FIG. 1) of the autonomous vehicle 110. In an embodiment, a light sensing module, as shown in FIG. 1, may be installed on the front side (a portion indicated by reference number 130 in FIG. 1) of the autonomous vehicle 110. In an embodiment, the display, as shown in FIG. 1, may be installed on the front side (a portion indicated by reference number 140 in FIG. 1) of the autonomous vehicle 110.

When the worker 150 intends to point out the autonomous vehicle 110, the worker 150 may point the light rod 170 toward the light sensor of the autonomous vehicle 110 and may press a laser switch mounted on the light rod 170, then a laser may be emitted from the light rod 170, so that the light sensor of the autonomous vehicle 110 may detect the laser and the display of the autonomous vehicle 110 may display that the autonomous vehicle 110 is pointed out. The worker 150 may confirm that the autonomous vehicle 110 is pointed out by looking at the displayed sign of the display, and may make a gesture in a state in which the worker 150 allows IR light to be emitted from the light rod 170. When the gesture is completed, the worker 150 may stop IR light emitting from the light rod 170. In the autonomous vehicle 110, a gesture of the worker 150 may be captured by the IR camera module and/or the camera module, a command of the worker 150 may be identified by analyzing the gesture, a corresponding command may be displayed on the display, and at the same time, a vehicle control may be performed to perform the corresponding command.

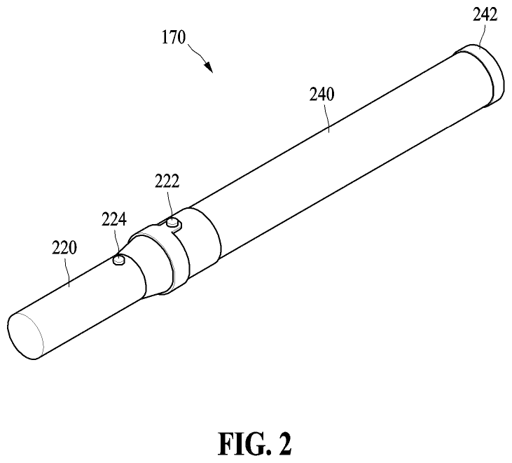

FIG. 2 is a diagram illustrating a structure of the light rod 170 of FIG. 1 according to an embodiment.

As shown in FIG. 2, the light rod 170 may have the shape of a rod having a convenient length for the worker 150 to make a gesture. The light rod 170 may include a handle 220 and a light emitter 240. The handle 220 may have the shape of a rod as shown but may also be formed in any shape that the worker 150 may hold conveniently. The handle 220 may be installed with a laser switch 222 and an IR switch 224. An IR emitter (not shown) for emitting IR light may be mounted on the inside of the light emitter 240. In an embodiment, the wavelength of IR light emitted from the light emitter 240 may be spaced apart from the wavelength range of IR light that may be emitted from a human. The light emitter 240 may be further mounted with a laser emitter 242 for emitting a laser. As illustrated, the laser emitter 242 may be installed at the upper end portion of the light emitter 240 so that a laser emitted from the laser emitter 242 may be emitted toward the direction indicated by the light rod 170. In an embodiment, the light emitter 240 may include an acrylic cover for accommodating the IR emitter and the laser emitter 242 inside the light emitter 240. The laser switch 222 installed on the handle 220 may be connected to the laser emitter 242 of the light emitter 240 and may be configured to turn the laser emitter 242 on or off. The IR switch 224 installed on the handle 220 may be connected to the IR emitter of the light emitter 240 and may be configured to turn the IR emitter on or off. In the illustrated embodiment, the IR switch 224 is implemented as a physical switch, but an embodiment in which the IR switch 224 is implemented as a module that automatically turns on the IR emitter by detecting movement of the light rod 170 is also possible.

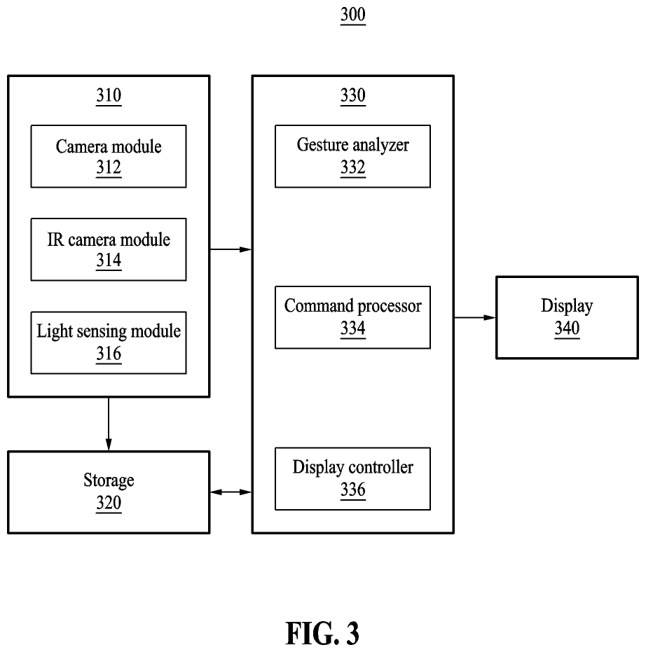

FIG. 3 is a block diagram illustrating an apparatus for interaction between a worker and an autonomous vehicle according to an embodiment.

As shown in FIG. 3, an apparatus 300 for interaction with the worker 150 may include a sensor unit 310, a storage 320, a controller 330, and a display 340. The sensor unit 310 may include a camera module 312, an IR camera module 314, and a light sensing module 316. The camera module 312 may be configured to continuously capture the outside of the autonomous vehicle 110, for example, the front side of the autonomous vehicle 110 and configured to output video frames. When the worker 150 makes a gesture outside the autonomous vehicle 110, the camera module 312 may capture the gesture and may output the gesture as first video frames. The first video frames output from the camera module 312 may be stored in the storage 320. The IR camera module 314 may be configured to detect IR light. The worker 150 may turn on the IR emitter of the light rod 170 from the outside of the autonomous vehicle 110, may make a gesture using the light rod 170, and then may turn off the IR emitter of the light rod 170. In this case, the IR camera module 314 may be configured to output a first signal indicating a point in time at which sensing of IR light emitted from the IR emitter starts and a second signal indicating a point in time at which the sensing of the IR light ends. The IR camera module 314 may be configured to continuously capture IR light incident on the IR camera module 314 from the outside of the autonomous vehicle 110, for example, from the front of the autonomous vehicle 110 and may be configured to output video frames. Similar to the camera module 312, the IR camera module 314 may capture a gesture of the worker 150, that is, IR light emitted from the light rod 170 of the worker 150 and may output second video frames including an IR light image (or an image of a light source of the IR light). The second video frames output from the IR camera module 314 may be stored in the storage 320. The light sensing module 316 may be configured to sense a laser. The light sensing module 316 may be configured to output a third signal in response to sensing the laser emitted from the laser emitter 242 of the light rod 170.

The storage 320 may be communicatively connected to the sensor unit 310 to store video frames output from the camera module 312 and/or the IR camera module 314. The storage 320 may further store software/firmware necessary for implementing the controller 330. The storage 320 may be implemented in at least one type of storage media of a flash memory type, a hard disk type, a multimedia card micro type, a card memory type (for example, secure digital (SD) or extreme digital (XE) memory), random access memory (RAM), static RAM (SRAM), read-only memory (ROM), electrically erasable programmable ROM (EEPROM), programmable ROM (PROM), magnetic memory, a magnetic disk, and an optical disk. However, one of ordinary skill in the art may understand that the implementation type of the storage 320 is not limited thereto.

The controller 330 may be communicatively connected to the sensor unit 310 and the storage 320. The controller 330 may include a gesture analyzer 332. In response to receiving the first signal and the second signal from the sensor unit 310, the gesture analyzer 332 may be configured to search for the first video frames and/or the second video frames stored in the storage 320 from the point in time indicated by the first signal to the point in time indicated by the second signal. The gesture analyzer 332 may identify a command of the worker 150 by analyzing the first video frames and/or the second video frames and may be configured to output a fourth signal indicating the command of the worker 150. The controller 330 may further include a command processor 334 communicatively connected to the gesture analyzer 332. The command processor 334 may be configured to perform at least one control operation for performing the command of the worker 150 in response to receiving the fourth signal from the gesture analyzer 332. The at least one control operation performed by the command processor 334 may include stopping, driving, generating a new movement path, and the like. For example, when a stopping operation is performed by the command processor 334, the autonomous vehicle 110 may be controlled to stop through a vehicle controller (not shown) of the autonomous vehicle 110. In another example, when a driving operation is performed by the command processor 334, the autonomous vehicle 110 may be controlled to start driving through the vehicle controller of the autonomous vehicle 110. The command processor 334 may be further configured to output a fourth signal and/or a fifth signal indicating an operation to be performed or currently being performed by the command processor 334. The controller 330 may further include a display controller 336 communicatively connected to the command processor 334 and/or the gesture analyzer 332. The display controller 336 may be configured to control an appropriate message to be displayed on the display 340 in response to receiving the fifth signal and/or the fourth signal. The display controller 336 may control messages to be displayed on the display 340 and the messages include, for example, “stopping, driving, and generating a path” indicating operations to be performed or currently being performed by the command processor 334. The display controller 336 may control a message indicating a command of the worker 150, for example, a message such as “start driving” to be displayed on the display 340. The display controller 336 may further configured to control a message indicating that the autonomous vehicle 110 is pointed out, for example, a message such as “pointed out” to be displayed on the display 340 in response to receiving the third signal indicating that a laser is detected from the sensor unit 310.

The display 340 may be further configured to display a message indicating an operation to be performed or currently being performed by the command processor 334, a message indicating the command of the worker 150, and/or a message indicating that the autonomous vehicle 110 is pointed out according to the control of the display controller 336. In an embodiment, the display 340 may be a light-emitting diode (LED) display including a plurality of LEDs, but one of ordinary skill in the art will understand that the display 340 may be implemented as a display other than an LED display.

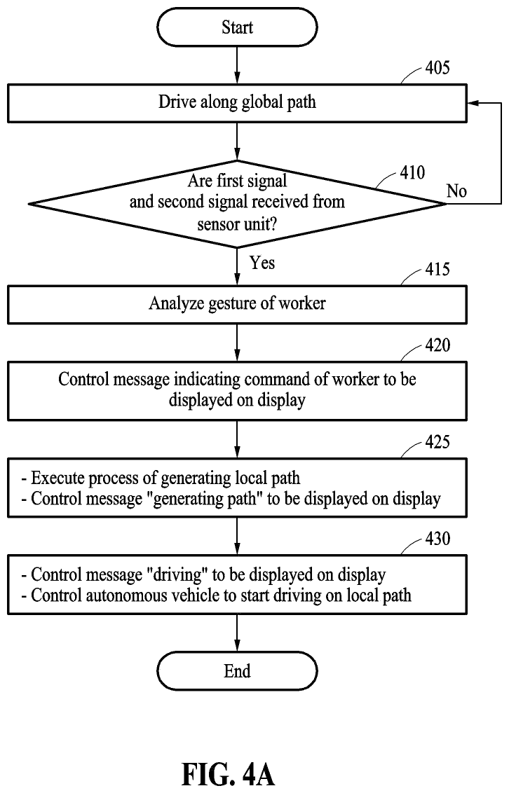

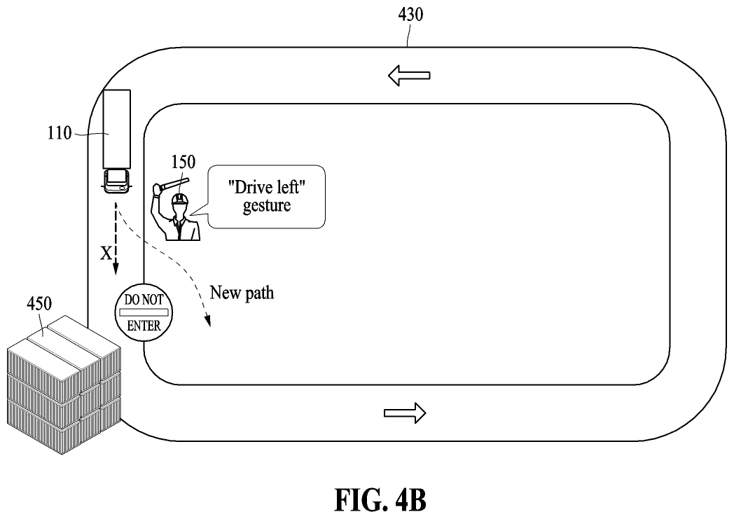

FIG. 4A is a flowchart illustrating an example of a method performed in an autonomous vehicle for interaction with a worker according to an embodiment. FIG. 4B is a diagram illustrating a scenario in which an obstacle occurs while an autonomous vehicle is driving on a global path and a worker guides to an avoidance path with a gesture.

As shown in FIG. 4B, the autonomous vehicle 110 may generate a global path 430 to perform a previously provided work schedule and may drive along the generated global path 430. When an accident occurs on the global path 430 or an object 450 temporarily interrupts the global path 430 while the autonomous vehicle 110 is driving, the autonomous vehicle 110 may need to enter the global path 430 again by avoiding only a section where the accident occurred or where the object 450 interrupted. In this case, the autonomous vehicle 110 may need to generate a local path for avoiding the section, but an optimal solution may not be obtained. In this case, a schedule delay may be minimized when the worker 150 provides guidance to the autonomous vehicle 110 at a corresponding location.

The method according to an embodiment may be performed by the controller 330 of FIG. 3 and may start from operation 405 in which the autonomous vehicle 110 drives along the global path 430. In operation 410, whether a first signal indicating a point in time at which sensing of IR light emitted starts and a second signal indicating a point in time at which the sensing of the IR light ends are received from the sensor unit 310 may be examined. As a result of the examination in operation 410, when the first signal and the second signal are determined not to be received, the process may return to operation 405. However, as a result of the examination in operation 410, when the first signal and the second signal are determined to be received, a gesture of the worker 150 may be analyzed in operation 415. In the present operation, the first video frames and/or the second frames stored in the storage 320 from the point in time indicated by the first signal to the point in time indicated by the second signal may be searched for, and by analyzing the found first video frames and the found second frames to identify the command of the worker, the fourth signal indicating the command of the worker may be output. The fourth signal may indicate, for example, the command of the worker to drive the autonomous vehicle 110 left. In operation 420, a message indicating the command of the worker, for example, “drive left” may be controlled to be displayed on the display 340. In operation 425, for example, a process of generating a local path to the left may be executed, and at the same time, a message “generating a path” may be controlled to be displayed on the display 340. In operation 430, a message “driving” may be controlled to be displayed on the display 340, and at the same time, the autonomous vehicle 110 may be controlled to start driving on a local path through a vehicle controller of the autonomous vehicle 110.

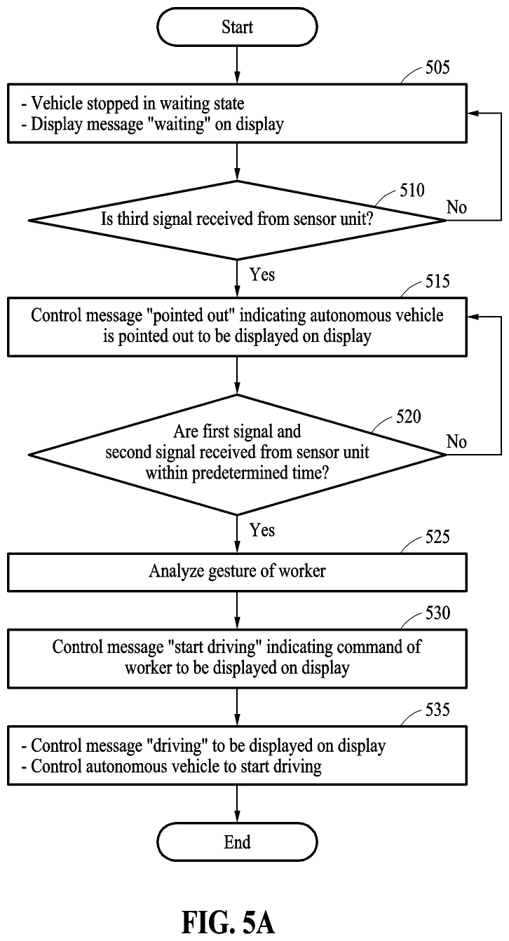

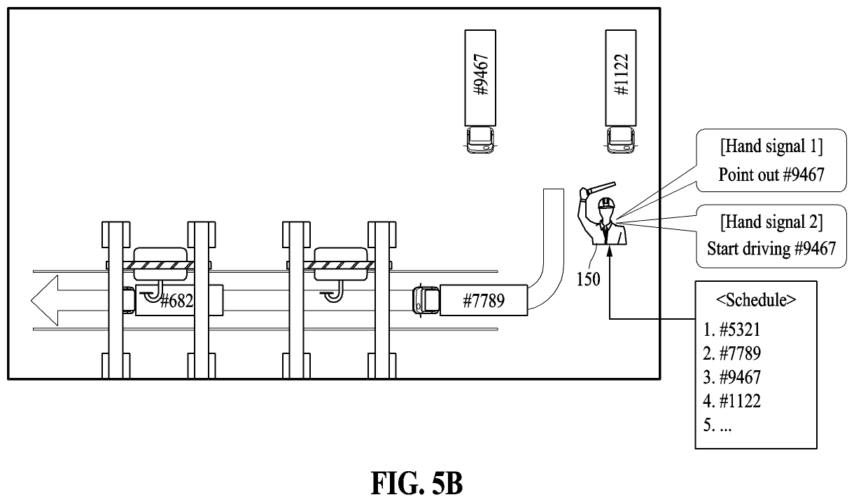

FIG. 5A is a flowchart illustrating another example of a method performed in an autonomous vehicle for interaction with a worker according to an embodiment. FIG. 5B is a diagram illustrating a scenario in which a worker points out a stopped autonomous vehicle using a light rod and performs a gesture to operate the autonomous vehicle.

According to the scenario illustrated in FIG. 5B, while several autonomous vehicles are stopped, the worker 150 may point out the autonomous vehicles in order according to a predetermined driving schedule, that is, a schedule in which a driving starts in an order of an autonomous vehicle No. 5321, an autonomous vehicle No. 7789, an autonomous vehicle No. 9467, an autonomous vehicle No. 1122, etc. to cause corresponding autonomous vehicles to drive. The flowchart of FIG. 5A is to explain a method performed in a corresponding autonomous vehicle as the worker 150 points out a specific autonomous vehicle, for example, the autonomous vehicle No. 9467, and makes a gesture to cause the autonomous vehicle to drive.

The method according to an embodiment may be performed by the controller 330 of FIG. 3 and may start from operation 505 in which the autonomous vehicle 110 is stopped in a waiting state. In the present operation, the display 340 may display a message “waiting”. In operation 510, whether a third signal indicating that a laser is sensed from the sensor unit 310 is received may be examined. As a result of the examination in operation 510, when the third signal is determined not to be received from the sensor unit 310, the process may return to operation 505. However, as a result of the examination in operation 510, when the third signal is determined to be received from the sensor unit 310, a message “pointed out” indicating that the autonomous vehicle 110 is pointed out may be controlled to be displayed on the display 340 in operation 515. In operation 520, whether a first signal indicating a point in time at which sensing of IR light emitted starts and a second signal indicating a point in time at which the sensing of the IR light ends are received from the sensor unit 310 within a predetermined time may be examined. As a result of the examination in operation 520, when the first signal and the second signal are determined not to be received within a predetermined time, the process may return to operation 515. However, as a result of the examination in operation 520, when the first signal and the second signal are determined to be received within a predetermined time, a gesture of the worker 150 may be analyzed in operation 525. In the present operation, the first video frames stored and/or the second frames in the storage 320 from the point in time indicated by the first signal to the point in time indicated by the second signal may be searched for, and by analyzing the found first video frames and the found second frames to identify the command of the worker, the fourth signal indicating the command of the worker may be output. The fourth signal may indicate, for example, the command of the worker to start driving the autonomous vehicle 110. In operation 530, a message “start driving” indicating the command of the worker may be controlled to be displayed on the display 340. In operation 535, a message “driving” may be controlled to be displayed on the display 340, and at the same time, the autonomous vehicle 110 may be controlled to start driving through a vehicle controller of the autonomous vehicle 110.

According to the embodiments described above, in a port environment where multiple autonomous vehicles load containers and the like and move according to pre-allocated path information, the autonomous vehicles may be controlled through hand signals of a worker such as a hand signal to change a moving path of an autonomous vehicle or a hand signal to provide timing to start driving, and thus, the transportation efficiency of the autonomous vehicles may be enhanced, and at the same time, situations such as path interference that may occur between multiple autonomous vehicles and a simulation delay that occurs due to rescheduling may be solved.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular; however, one of ordinary skill in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc-read only memory (CD-ROM) and digital video discs (DVDs); magneto-optical media such as optical discs; and hardware devices that are specially configured to store and perform program instructions, such as ROM, random access memory (RAM), flash memory, and the like. Examples of program instructions include both machine code, such as produced by a compiler, and files containing higher level code that may be executed by the computer using an interpreter.

The above-described hardware devices may be configured to act as one or more software modules in order to perform the operations of the above-described embodiments, or vice versa.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and equivalents to the claims are also within the scope of the following claims.

What is claimed is:

1. An apparatus for an interaction between a worker and an autonomous vehicle, the apparatus comprising:
a sensor unit comprising an infrared (IR) camera module and a light sensing module;
a controller communicatively connected to the sensor unit and comprising a gesture analyzer, a command processor, and a display controller;
a display communicatively connected to the display controller; and
a storage connected to the sensor unit and the controller,
wherein the IR camera module is configured to output video frames by capturing IR light incident on the IR camera module, wherein the video frames are stored in the storage, and further configured to output a first signal indicating a point in time at which sensing of IR light emitted from a light rod outside the autonomous vehicle starts and a second signal indicating a point in time at which the sensing of the IR light emitted from the light rod ends,
wherein the light sensing module is configured to output a third signal in response to sensing a laser emitted from the light rod,
wherein the gesture analyzer is configured to search for first video frames stored in the storage from the point in time indicated by the first signal to the point in time indicated by the second signal, in response to receiving the first signal and the second signal, configured to identify a command of the worker by analyzing the found first video frames, and configured to output a fourth signal indicating the command of the worker,
wherein the command processor is configured to perform at least one control operation for performing the command of the worker in response to receiving the fourth signal, and further configured to output a fifth signal indicating the at least one control operation, and
wherein the display controller is configured to control a message indicating the at least one control operation to be displayed on the display in response to receiving the fifth signal and further configured to control a message indicating that the autonomous vehicle is pointed out to be displayed on the display in response to receiving the third signal.

2. The apparatus of claim 1, wherein the sensor unit further comprises a camera module,
wherein the camera module is configured to capture an outside of the autonomous vehicle and output second video frames, and the second video frames are stored in the storage.

3. The apparatus of claim 2, wherein the gesture analyzer is configured to further search for the second video frames stored in the storage from the point in time indicated by the first signal to the point in time indicated by the second signal, in response to receiving the first signal and the second signal, and further configured to output the fourth signal based on an analysis of the found first video frames and the found second video frames.

4. The apparatus of claim 2, wherein the IR camera module, the light sensing module, and the camera module are installed on a front side of the autonomous vehicle.

5. The apparatus of claim 1, wherein the display is a light-emitting diode (LED) display.

6. The apparatus of claim 1, wherein the at least one control operation comprises at least one of stopping, driving, or generating a new movement path.

7. The apparatus of claim 1, wherein the display controller is further configured to control a message indicating the command of the worker to be displayed on the display in response to receiving the fourth signal.

8. A method performed in an autonomous vehicle for an interaction with a worker, the method comprising:
storing video frames output by capturing an outside of the autonomous vehicle;
identifying a command of the worker based on the video frames;
controlling a message indicating the command of the worker to be displayed on a display;
performing at least one control operation for performing the command of the worker; and
controlling a message indicating the at least one control operation to be displayed on the display.

9. The method of claim 8, wherein the identifying of the command of the worker based on the video frames comprises:
in response to generating a first signal indicating a point in time at which sensing of infrared (IR) light emitted from a light rod outside the autonomous vehicle starts and a second signal indicating a point in time at which the sensing of the IR light emitted from the light rod ends, searching for the stored video frames from the point in time indicated by the first signal to the point in time indicated by the second signal; and identifying the command of the worker by analyzing the found video frames.

10. The method of claim 8, wherein:
the performing of the at least one control operation for performing the command of the worker comprises executing a process of generating a local path, and
the controlling of the message indicating the at least one control operation to be displayed on the display comprises controlling a message indicating that a local path is being generated to be displayed on the display.

11. A method performed in an autonomous vehicle for an interaction with a worker, the method comprising:
storing video frames output by capturing an outside of the autonomous vehicle;
in response to sensing a laser emitted from a light rod outside the autonomous vehicle, controlling a message indicating that the autonomous vehicle is pointed out to be displayed on a display;
in response to generating a first signal indicating a point in time at which sensing of infrared (IR) light emitted from the light rod outside the autonomous vehicle starts and a second signal indicating a point in time at which the sensing of the IR light emitted from the light rod ends within a predetermined time after the laser is sensed, identifying the command of the worker based on the video frames;
controlling a message indicating the command of the worker to be displayed on the display;
performing at least one control operation for performing the command of the worker; and
controlling a message indicating the at least one control operation to be displayed on the display.

12. The method of claim 11, wherein the identifying of the command of the worker based on the video frames comprises:
searching for video frames stored from a point in time indicated by the first signal to a point in time indicated by the second signal; and
identifying the command of the worker by analyzing the found video frames.

13. The method of claim 11, wherein the controlling of the message indicating the command of the worker to be displayed on the display comprises controlling a message indicating a command to start driving to be displayed on the display.

14. The method of claim 11, wherein the performing of the at least one control operation for performing the command of the worker comprises controlling the autonomous vehicle to start driving.

15. A non-transitory computer-readable storage medium storing instructions that, when executed by a processor, cause the processor to perform the method of claim 8.
